(19) United States
(12) Patent Application Publication
(10) Pub. No.: US 2015/0142916 A1
(43) Pub. Date: May 21, 2015

(54) METHOD FOR TRANSLATING ENTITY TO THINGS BASED ON WEB AND MACHINE-TO-MACHINE COMMUNICATION DEVICE

(71) Applicant: Electronics and Telecommunications Research Institute, Daejeon (KR)

(72) Inventors: Myung Nam BAE, Daejeon (KR); Hyo Chan BANG, Daejeon (KR)

(21) Appl. No.: 14/533,812

(22) Filed: Nov. 5, 2014

(30) Foreign Application Priority Data
Nov. 20, 2013 (KR) 10-2013-0141602
May 14, 2014 (KR) 10-2014-0057773

(51) Int. Cl. H04L 29/08; H04L 29/06

(52) U.S. Cl. CPC H04L 67/02; H04L 67/06; H04L 69/08
USPC 709/218

(57) ABSTRACT

Provided is a method for translating connectivity of an entity to a Web. The method for translating an entity to things based on a Web includes dividing the individual entity into a virtualization part that declares request and control with respect to things and a specialization part that specializes a request with respect to things and removes a restriction of the individual entity, and translating the same, and defining a mapping rule between a characteristic of the individual entity and a connectivity technology supported by a Web in the specialization part.

### CROSS-REFERENCE TO RELATED APPLICATIONS

This application claims priority under 35 U.S.C. §119 to Korean Patent Application No. 10-2013-0141602, filed on Nov. 20, 2013, and to Korean Patent Application No. 10-2014-0057773, filed on May 14, 2014, the disclosure of which is incorporated herein by reference in its entirety.

### TECHNICAL FIELD

The present invention relates to a method for translating an entity to things and a machine-to-machine communication device, and more particularly, to a method for translating a specialization part of things independently from individual connectivity technologies supported by a Web, and a machine-to-machine communication device.

### BACKGROUND

As communication and IT technologies have continued to advance, various types of devices have become prevalent and an environment allowing users to access and obtain information anytime and anywhere has been established. Thus, currently, ITU-T WoT/IoT, ETSI M2M, and the like, have proposed a connectivity technology integrating devices into a single communication and identification system, and the like, and controlling the same.

In particular, a Web of things (WoT) technology proposes a scheme of associating and developing (restricted) legacy devices representing real-world entities in terms of a Web technology. An entity may be materialized into a physical device such as a sensor or an actuator, and in this case, there may be various restrictions (for example, a connection scheme, an operating time, and the like) depending on operating environments or characteristics of devices. Also, an entity may be materialized into a network device.

A thing represents a unit entity that may be identified on a Web through a connectivity technology. In this case, a thing exist by two parts. A first part is a part that virtually exists within an individual connectivity technology and declares requesting and control with respect to things. A second part is a part that serves to remove restrictions (diversity of operation control procedures or a difference in expressive interfaces) of entities by specializing requests (for example, a data request, a control request, or the like) with respect to things.

These connectivity technologies define an exchange scheme for expressing and associating virtualization parts of legacy devices realizing entities, using various Web technologies (REST, HTTP, SOAP, WADL, and the like).

However, these connectivity technologies do not define a method for configuring a specialization part of actual things corresponding to the virtualization part during a process of translating a legacy device into a thing. Thus, a problem of a difference in interfaces based on various combinations between the specialization part of things and connectivity technologies arises. Thus, the development of a technique capable of facilitating switching to a new connectivity technology or an application of a new connectivity technology to a device is required.

### SUMMARY

Accordingly, the present invention provides a method for translating an entity to things based on a Web capable of removing operational restrictions of an individual legacy device and guaranteeing interoperability between an entity and a connectivity technology through the generalization of an interface with a virtualization part, and a machine-to-machine communication device.

In one general aspect, a method for translating an entity to things based on a Web, which can be implemented by a computer providing connectivity of an individual entity to a Web, includes: dividing the individual entity into a virtualization part that declares request and control with respect to things and a specialization part that specializes a request with respect to things and removes a restriction of the individual entity, and translating the same; and defining a mapping rule between a characteristic of the individual entity and a connectivity technology supported by a Web in the specialization part.

In another general aspect, a machine-to-machine communication device based on a Web providing connectivity of an individual entity to a Web includes: a things description unit configured to store a things description (or a things specification) describing an attribute of a logical device or a physical device constituting the machine-to-machine communication device and an operation executable by the logical device or the physical device; and a things implementation unit configured to specialize an association procedure with respect to a things mediation server based on the things description.

In another general aspect, a method for translating an entity to things based on a Web, which can be implemented by a computer providing connectivity of an individual entity to a Web, includes: translating a feature and function of a logical device or a physical device constituting a machine-to-machine communication device into an attribute of the logical device or the physical device or an operation executable by the logical device or the physical device; defining a mapping rule for sharing the attribute or the operation with a things mediation server; defining a things description that declares an attribute or an operation to be published, among the attribute or the operation; and specializing an association procedure with respect to the things mediation server based on the things description.

### BRIEF DESCRIPTION OF THE DRAWINGS

FIG. 1 is a conceptual view illustrating a hierarchical structure of translating an entity into things according to an embodiment of the present invention.

FIG. 2 is a block diagram of a system illustrating an environment in which a machine-to-machine communication device of an entity based on a Web.

FIG. 3 is a block diagram illustrating an internal configuration of a things implementing unit illustrated in FIG. 2.

FIG. 4A is a conceptual view illustrating an operation interface for a device-things router illustrated in FIG. 3.

FIG. 4B is a conceptual view illustrating a publish operation of the device-things router illustrated in FIG. 3.

FIG. 4C is a conceptual view illustrating an operation execution operation of the device-things router illustrated in FIG. 3.

FIG. 4D is a conceptual view illustrating an operation result publish operation of the device-things router illustrated in FIG. 3.

FIG. 5 is a block diagram illustrating things abstraction by a physical/logic al device.

FIG. 6 is a flow chart illustrating a method of translating an entity into things based on a Web according to an embodiment of the present invention.

FIG. 7 is a flow chart illustrating an interface procedure for operating things according to an embodiment of the present invention.

FIG. 8 is a view illustrating a procedure of interoperation between the machine-to-machine communication devices according to an embodiment of the present invention.

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art. The terms used herein are for the purpose of describing particular embodiments only and are not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, exemplary embodiments of the present invention will be described in detail with reference to the accompanying drawings. In adding reference numerals for elements in each figure, it should be noted that like reference numerals already used to denote like elements in other figures are used for elements wherever possible. Moreover, detailed descriptions related to well-known functions or configurations will be ruled out in order not to unnecessarily obscure subject matters of the present invention.

In the present disclosure, things refer to a machine-to-machine communication device having an association procedure for communication with the exterior defined through a translation process, and hereinafter, things and a machine-to-machine communication device will be used together.

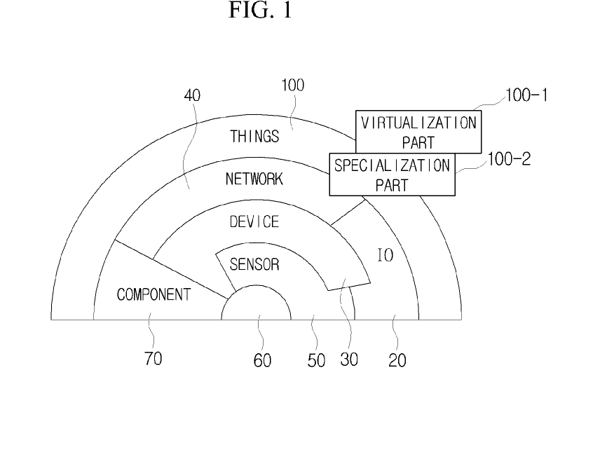

FIG. 1 is a conceptual view illustrating a hierarchical structure of translating an entity into things according to an embodiment of the present invention.

Referring to FIG. 1, a real-world entity 60 is mapped to things 100 through translation. The mapped things 100 include a virtualization part 100-1 and a specialization part 100-2, and the virtualization part 100-1 may be used by various connectivity technologies (for example, REST, HTTP, SOAP, WADL, etc.) supported on a Web.

In the present disclosure, the virtualization part 100-1 refers to a part virtually exists within an individual connectivity technology and declares requesting and controlling with respect to things, and the specialization part is a part that serves to actually specialize requests (for example, a data request, a control request, or the like) with respect to things and removes restrictions (diversity of operation control procedures or difference in expressive interfaces) of entities.

According to the translation method of the present invention, a real-world entity (for example, a temperature or a person) 60 may be translated into things 100 in various manners.

As an embodiment of the translation method according to the present invention, a process of translating a temperature entity will be described. The temperature entity 60 is digitized through a sensor 50 and may be mounted on a device 30 physically separated from the things 100. The device 30 may be mapped to the things 100 via a network 40 or may be physically connected to the things 100 via an IO 20.

As another embodiment of the translation method according to the present invention, a process of translating a logical person entity will be described. The person entity 60 is modeled through a seriate software component 70 and may be translated into things 100.

On the other hand, the real-world particular entity 60 may be translated into things 100 via the IO 20 without passing through the network 40.

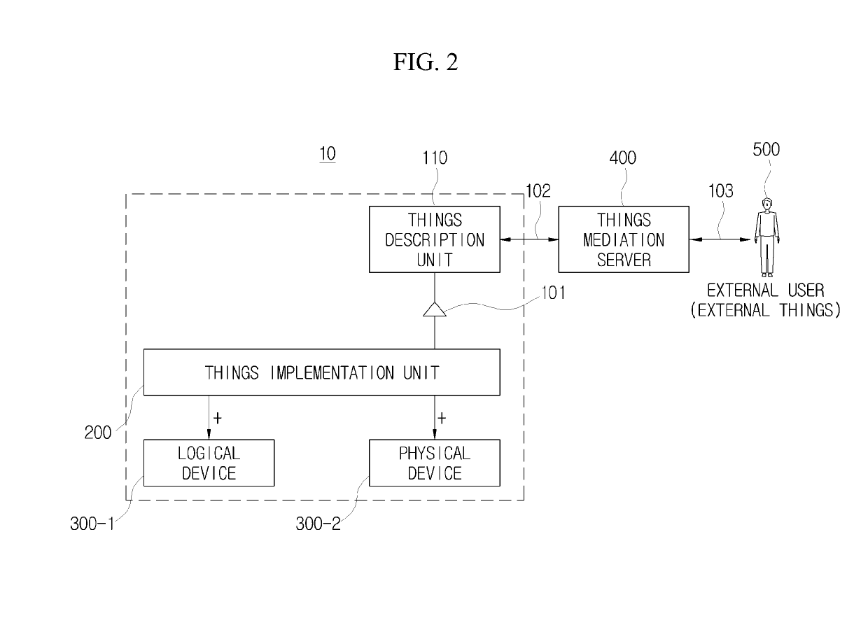

FIG. 2 is a block diagram of a system illustrating an environment in which a machine-to-machine communication device of an entity based on a Web.

Referring to FIG. 2, a machine-to-machine communication device 10 according to an embodiment of the present invention includes a things description unit 110, a things implementation unit 200, and device units 300-1 and 300-2.

The machine-to-machine communication device 10 according to an embodiment of the present invention is connected to a things mediation server (or service) 400 via a Web/Internet protocol 102. The things mediation server 400 supports connection between the machine-to-machine communication device 10 and a remote user (or a remote machine-to-machine communication device) 500 using a self-connectivity technology, and provides an interface for interoperation.

To this end, the things mediation server 400 stores a things description (or a things specification) of each machine-to-machine communication device 10, and publishes the things description to allow a unique access method, function, role, and the like, provided by a particular machine-to-machine communication device to be shared with a different machine-to-machine communication device.

The machine-to-machine communication device 10 publishes a things description to the things mediation server 400 according to a standard of the things mediation server 400. Here, the things description describes an attribute of the logical device 300-1 or the physical device 300-2 constituting the machine-to-machine communication device 10 and an operation that may be performed by the logical device 300-1 or the physical device 300-2.

The machine-to-machine communication device 10 includes the things description unit 110, the things implementation unit 200, and at least one logical device 300-1 or physical device 300-2.

The things description unit 110 stores things description describing an attribute and a function of at least one logical unit 300-1 or physical unit 300-2.

The things implementation unit 200 specializes an association procedure with respect to the things mediation server 400 based on the things description stored in the things description unit 110. Also, the things implementation unit 200 performs a procedure for mapping between the specialized association procedure and actual legacy devices (the logical device 300-1 or the physical device 300-2).

In detail, the things implementation unit 200 may perform a procedure for mapping between the at least one logical device 300-1 or the physical device 300-2 and the things mediation server 400, and publishes a characteristic and a function of each device to the things mediation server 400 through the things description. The external user (or external things) 500 may access the characteristic and function of the actual legacy devices 300-1 and 300-2 based on the published things description and control the same.

Here, the physical device 300-2 may be configured as an individual entity such as a network, a device, an IO, a sensor, or the like, or may be combined to various forms so as to be configured.

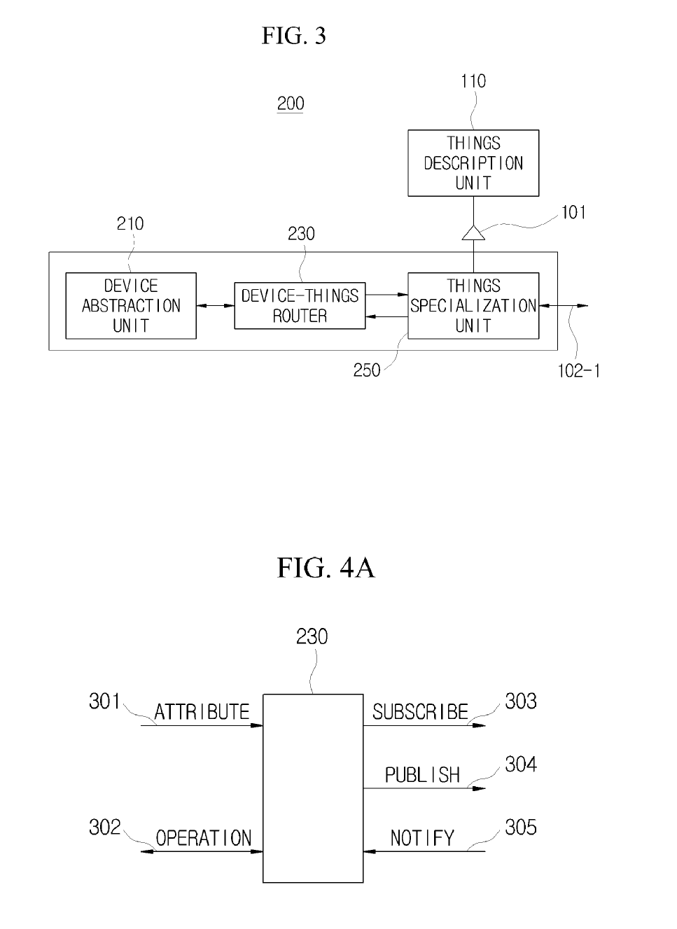

FIG. 3 is a block diagram illustrating an internal configuration of the things implementation unit illustrated in FIG. 2.

Referring to FIGS. 2 and 3, the things implementation unit 200 according to an embodiment of the present invention includes a device abstraction unit 210, a device-things router 230, and a things specialization unit 250.

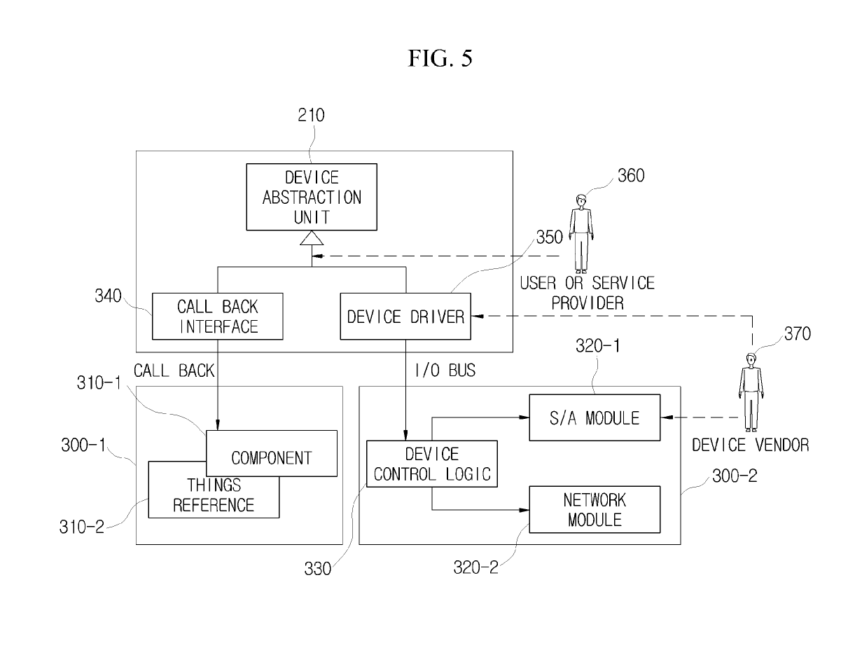

The device abstraction unit 210 abstracts the logical device 300-2 or the physical device 300-2 to define an attribute and an executable operation from the corresponding device. Hereinafter, an abstraction configuration of the physical/logical device will be described with reference to FIG. 5 illustrating abstraction of the physical/logical device.

Referring to FIG. 5, for example, the machine-to-machine communication device 10 may be configured as a device form including only a software component 300-1 or a device form including a hardware device 300-2.

The software component or logical device 300-1, a device form (non-digital) without a physical entity, may include a things reference 310-2 for combining existing machine-to-machine communication devices 10 or a component 310-1 providing an abstracted entity expressed through a non-physical characteristic/operation.

The things reference 310-2 is a reference with respect to the predefined machine-to-machine communication devices 10, which is used to configure a new machine-to-machine communication device 10 by combining the machine-to-machine communication devices 10. In this case, the software things 100 including the things reference 310-2 may be re-defined to extended/abstracted things apart from the definition of the existing machine-to-machine communication devices. For example, the things reference 310-2 may be used to define new “weather things” by combining “temperature things” and “humidity things”.

Meanwhile, a device driver 350 of the hardware device or physical device 300-2 provides characteristics (for example, an address, a size of an IO buffer, and the like) of a corresponding device, includes an address for controlling, and performs controlling (read/write) therethrough.

In this case, the hardware device 300-2 includes a network module 320-2 and a device control logic 330 has a network management function. Here, the hardware device 300-2 may be defined as a network-type thing.

On the other hand, the hardware device 300-2 has the network module 320-2, but the device control logic 330 may have only a communication (connection) management function. In this case, the hardware device 300-2 may be defined as a device-type thing.

The hardware device 300-2 may selectively include an S/A module 320-1 including a certain number of sensors or actuators digitizing a physical entity and the network module 320-2. For example, the hardware device 300-2 may include a plurality of S/A modules and a single network module, may include only a network module without an S/A module, or only include the S/A module without a network module.

The device control logic 330 controls physical characteristics and an operation of the hardware device 300-2. In this case, the device control logic 330 may be provided differently depending on a configuration type (network type, device type, or S/A type) of the hardware device 300-2. For example, a network-type control logic includes an operation allowing for joining between sub-devices on a network. Meanwhile, a device-type control logic includes an operation requesting joining from a network.

The hardware device 300-2 and the device driver 350 are proposed by a device vender 370. Meanwhile, device abstracting through things description of the hardware device 300-2 is made by a user or service provider 360.

Referring back to FIG. 3, the things specialization unit 250 will be described.

The things specialization unit 250 performs an association/connection 102-1 procedure between the machine-to-machine communication device 10 and the things mediation server 400 through specialization 101 of things description. Here, things description is stored in the things mediation server 400 and published through the things description unit 110.

The things specialization unit 250 declares things description using a basic operation of subscribe, publish, and notify, and configure an association procedure with respect to the things mediation server 400.

The device-things router 230 maps the attribute and operation of the device abstracted by the device abstraction unit 210 and the association procedure with respect to the things mediation server 400 defined by the things specialization unit 250.

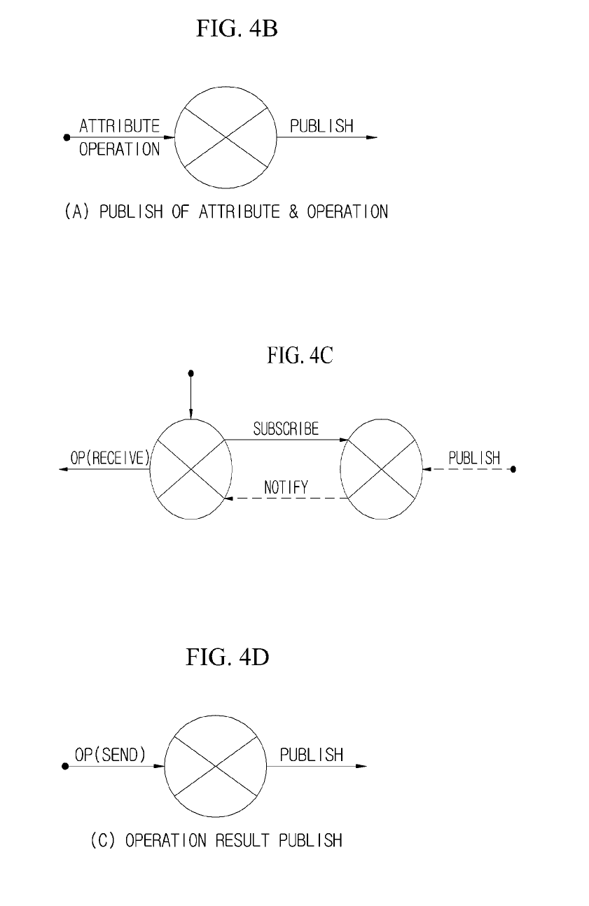

As illustrated in FIG. 4A illustrating an operation interface for the device-things router 230, device abstraction is specialized to the logical device 300-1 or the physical device 300-2 to be included in the actual machine-to-machine communication device 10, and each of the devices 300-1 and 300-2 provides an attribute 301 and an executable operation 302.

Here, the attribute 301 includes <tag, value or value-list>, and the tag, an identifier, is uniquely identified by the devices 300-1 and 300-2.

The operation 302 specifies dynamically performed or controlled operations, and an operation to the device-things router 230 is proposed as data (or a data stream) as a result of periodical operation or control. An operation from the device-things router 230 to the device abstraction unit 210 refers to a request for performing an aperiodical operation or control.

FIG. 4B is a conceptual view illustrating a publish operation of the device-things router illustrated in FIG. 3.

Referring to FIG. 4B, the device-things router 230 publishes the attribute 301 and the operation 302 of the devices 300-1 and 300-2 to the things mediation server 400 according to the things description stored in the things description unit 110. Also, the device-things router 230 publishes the result of the operation 302 to the things mediation server 400.

FIG. 4C is a conceptual view illustrating an operation execution operation of the device-things router illustrated in FIG. 3.

Referring to FIG. 4C, when the device-things router 230 receives the notify 305 from the things mediation server 400 according to the description of the published operation 302, the device-things router 230 translates the received notify 305 into the operation 302 of the corresponding device 300-1 or 300-2 and delivers the translated operation 302 to the corresponding device 300-1 or 300-2.

FIG. 4D is a conceptual view illustrating an operation result publish operation of the device-things router illustrated in FIG. 3.

Referring to FIG. 4D, the device-things router 230 publishes the result of operation performed by the device 300-1 or 300-2 to the things mediation server 400.

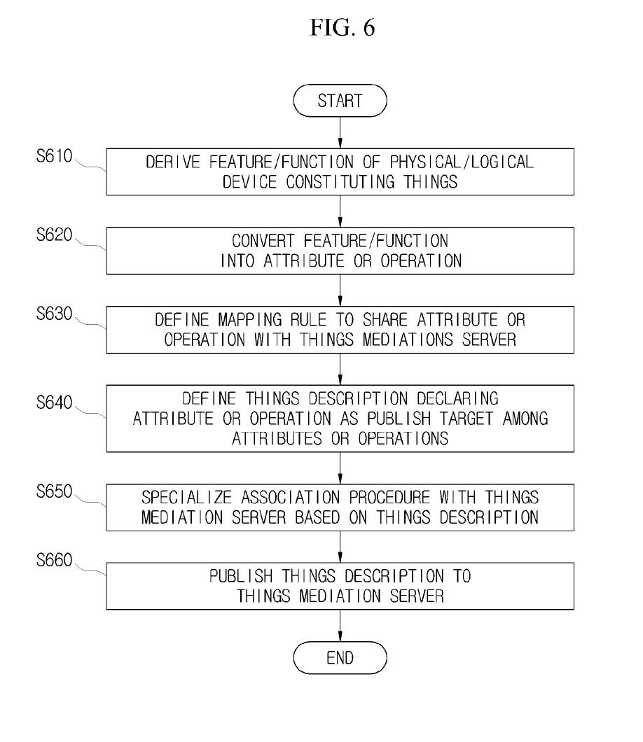

FIG. 6 is a flow chart illustrating a method of translating an entity into things based on a Web according to an embodiment of the present invention. Hereinafter, a subject of performing each step will be considered as the things implementation unit 200, unless otherwise mentioned.

In step S610, the things implementation unit 200 derives a unique feature and function of the logical device 300-1 or the physical device 300-2 constituting the machine-to-machine communication device 10.

In step S620, the things implementation unit 200 defines the derived feature and function of the device 300-1 or 300-2, as an attribute and an operation through abstraction process.

In step S630, the things implementation unit 200 defines a mapping rule for sharing the attribute and operation of the device 300-1 or 300-2 with the exterior of the machine-to-machine communication device 10. Here, the mapping rule includes a scheme for providing the attribute and operation result of things and a scheme of translating a control request received from the exterior into an internal operation.

In step S640, the things implementation unit 200 defines things description to be published, among the attribute and operation of the device, through translation. Here, since the machine-to-machine communication device 10 needs to support a Web interface, the things description may be described as WADL or WSDL.

In step S650, the things implementation unit 200 specializes an association procedure to be performed based on the defined things description (505). For example, this process may include definition of the association procedure between the things mediations server 400 and the machine-to-machine communication device 10. Here, the definition of the association procedure may be implemented by a handle with respect to a Web interface.

In step S660, when the translation procedure is completed, the things implementation unit 200 publishes the things description defined in step S640 to the things mediation server 400 in order to activate the machine-to-machine communication device 10 as an actual thing 100.

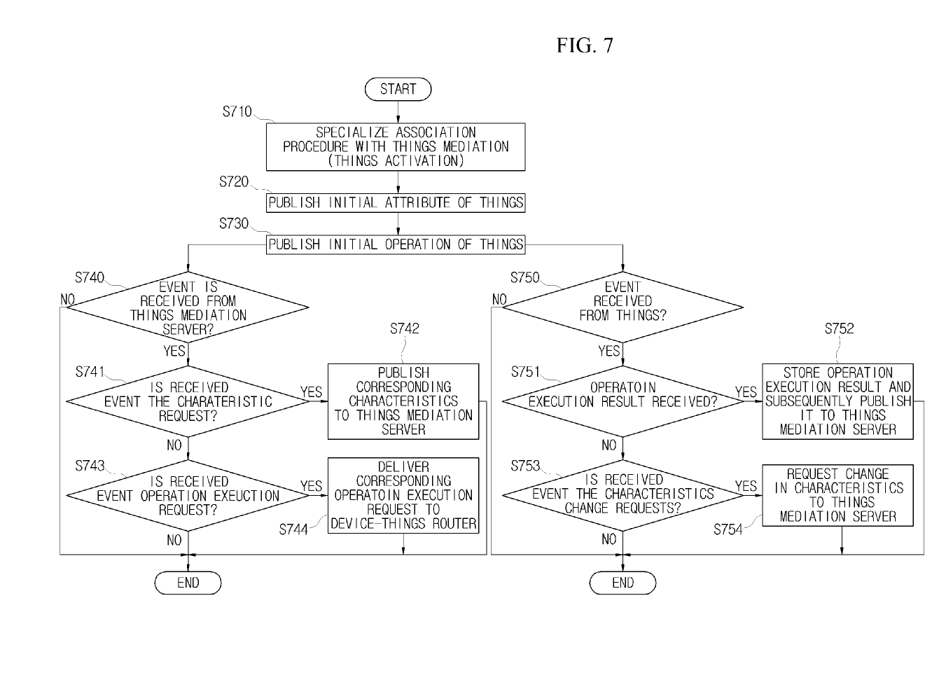

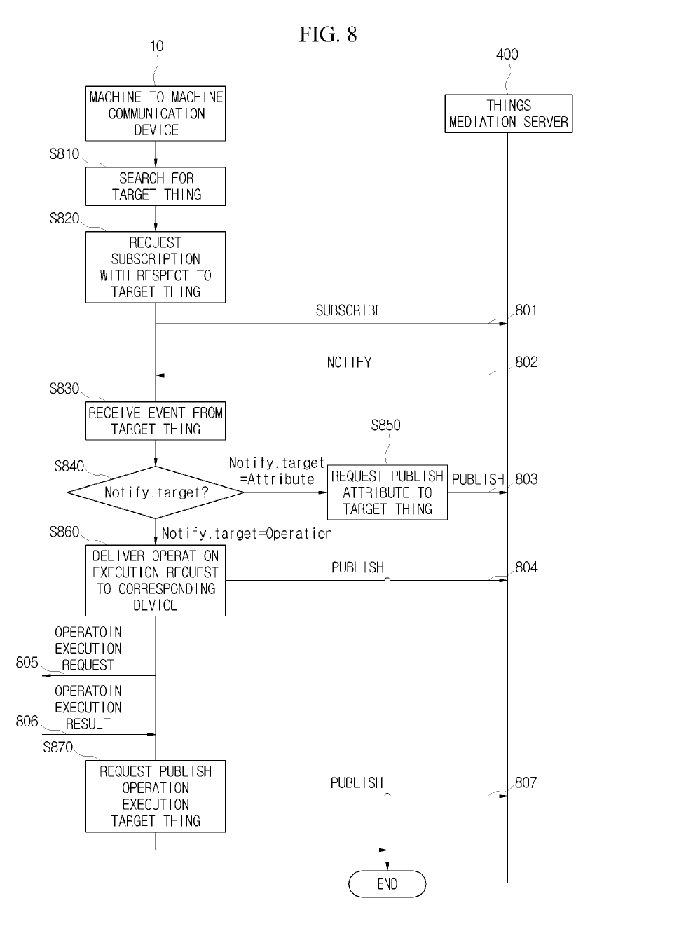

So far, the translation method providing connectivity of an entity to a Web and the configuration of the machine-to-machine communication device 10 based on the method have been described. Hereinafter, an operation interface according to a change in the interior and exterior of the machine-to-machine communication device 10 and an interoperation procedure with external machine-to-machine communication devices will be described in detail with reference to FIGS. 7 and 8.

When translation of a software and hardware-type device is completed, it is activated with the machine-to-machine communication device 10 that can communicate with the external through the things mediation server 400. Thereafter, an interface procedure allowing for operation of things according to a change in the interior or exterior of the things is shown.

FIG. 7 is a flow chart illustrating an interface procedure allowing for operation of things according to an embodiment of the present invention.

Referring to FIG. 7, in step S710, things description is published to the things mediation server 400, and an association procedure between the things mediation server 400 and the machine-to-machine communication device 10 is specialized.

In step S720, the machine-to-machine communication device 10 publishes an initial attribute of things. In detail, the machine-to-machine communication device 10 publishes an initial attribute list and value of the logical device or the physical device constituting things to the things mediation server 400.

In step S730, the machine-to-machine communication device 10 publishes a list of executable operations to the things mediation server 400.

Thereafter, the machine-to-machine communication device 10 may receive a particular event from the external things mediations server 400 or may receive a particular event from an internal logical or physical device.

For example, it is assumed that the machine-to-machine communication device 10 receives an event from the things mediation server 400 in step S740. In this case, the machine-to-machine communication device 10 determines whether the event requests characteristics of things in step S741, and when it is determined that the event requests characteristics of things, the machine-to-machine communication device 10 stores the corresponding characteristics and publishes the corresponding characteristics to the things mediation server 400 in step S742.

On the other hand, in a case that the received event is a request for execution of a particular operation that can be performed by things in step S743, the event is delivered to the device-things router 230 of the machine-to-machine communication device 10 in step S744.

For example, it is assumed that the machine-to-machine communication device 10 receives an event from a logical or physical device therein in step S750. In detail, when the event is received from the device-things router 230, it is determined whether the received event is reception of an operation execution result from the logical or physical device in step S751. When the received event is reception of an operation execution result, the result is stored and subsequently published to the things mediation server 400 in step S752.

On the other hand, when the received event is a request for changing characteristic (generation, correction, or deletion) in step S753, the corresponding characteristics publish is delivered as a change request event to the things mediation server 400 in step S754.

FIG. 8 is a view illustrating a procedure of interoperation between things according to an embodiment of the present invention.

Mutual association between the machine-to-machine communication devices 10 is made through the things mediation server 400, and this is implemented by three operations of subscribe, publish, and notify. The association procedure between the machine-to-machine communication device 10 is shown in FIG. 8.

The machine-to-machine communication device 10 may search for a things description of a target thing (not shown) through the things mediation server 400, or the like, and the machine-to-machine communication device 10 requests subscription 801 with respect to the target thing such that the things mediation server 400 allows for a request with respect to the target thing in step S820.

Thereafter, the machine-to-machine communication device 10 receives a request generation notify 802 from the target thin to the thing mediation server 400 in step S830.

Thereafter, the machine-to-machine communication device 10 checks the received published target in step S840.

If the target of the received notify is an attribute, the machine-to-machine communication device 10 publishes a corresponding attribute 803 to the target thing through the thing mediation server 400 in step S850.

If the target of the received publish is an operation, the publish is delivered to the device 300-1 or 300-2 of the thing in step S860 and the device 300-1 or 300-2 of the thing is requested to execute the corresponding operation (805). Also, the reception/processing situation 804 of the publish is immediately published to the target thing.

Thereafter, when the operation execution result 806 is received from the device 300-1 or 300-2 of the thing is received, the things mediation server 400 is requested to publish an operation result 802 to the target thing in step 870.

As described above, according to the present invention, in the process of translating an entity to things, things may be configured to be independent from individual connectivity technology supported by a Web.

Also, in the method of configuring a specialization part for managing and controlling an actual legacy device, operational restriction of an individual legacy device may be removed and an interoperability problem between an entity and a connectivity technology may be solved through generalization of a virtualization part and an interface.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for translating an entity to things based on a Web, which can be implemented by a computer providing connectivity of an individual entity to a Web, the method comprising:
dividing the individual entity into a virtualization part that declares request and control with respect to things and a specialization part that specializes a request with respect to things and removes a restriction of the individual entity, and translating the same; and
defining a mapping rule between a characteristic of the individual entity and a connectivity technology supported by a Web in the specialization part.

2. The method of claim 1, wherein the defining of a mapping rule comprises translating the individual entity to things using mapping between a characteristic of the individual entity and a publish-subscribe pattern of a connectivity technology supported by a Web.

3. A machine-to-machine communication device based on a Web providing connectivity of an individual entity to a Web, the machine-to-machine communication device comprising:
a things description unit configured to store a things description describing an attribute of a logical device or a physical device constituting the machine-to-machine communication device and an operation executable by the logical device or the physical device; and
a things implementation unit configured to specialize an association procedure with respect to a things mediation server based on the things description.

4. The machine-to-machine communication device of claim 3, wherein the things implementation unit defines a mapping rule between the attribute and the operation and the association procedure.

5. The machine-to-machine communication device of claim 4, wherein the mapping rule comprises at least one of a rule for providing a result of the attribute and the operation and a rule for translating a control request with respect to the logical device or the physical device received from the exterior into an internal operation for the corresponding logical device or the corresponding physical device.

6. The machine-to-machine communication device of claim 3, wherein the things implementation unit configures a function and a procedure of the things mediation server based on the things description, wherein the attribute and the operation of the things description are declared by a subscribe, publish, and notify operation.

7. The machine-to-machine communication device of claim 3, wherein the things description is delivered to the things mediation server according to a standard of the things mediation server.

8. The machine-to-machine communication device of claim 3, wherein the things implementation unit comprises:
a device abstraction unit configured to translate a feature and a function of the logical device or the physical device into the attribute or the operation;
a device-things router configured to define a mapping rule for sharing the attribute or the operation with the things mediation server; and
a things specialization unit configured to define the things description that declares an attribute or an operation to be published, among the attribute and the operation, and configure a function and a procedure of the things mediation server based on the things description.

9. A method for translating an entity to things based on a Web, which can be implemented by a computer providing connectivity of an individual entity to a Web, the method comprising:
translating a feature and a function of a logical device or a physical device constituting a machine-to-machine communication device into an attribute of the logical device or the physical device or an operation executable by the logical device or the physical device;
defining a mapping rule for sharing the attribute or the operation with a things mediation server;
defining a things description that declares an attribute or an operation to be published, among the attribute or the operation; and
specializing an association procedure with respect to the things mediation server based on the things description.

10. The method of claim 9, wherein the defining of a mapping rule comprises at least one of a rule for providing a result of the attribute and the operation and a rule for translating a control request with respect to the logical device or the physical device received from the exterior into an internal operation for the corresponding logical device or the corresponding physical device.

11. The method of claim 9, wherein the defining of a things description comprises defining an attribute or an operation to be published, among the attribute and the operation, using a subscribe, publish, and notify operation.

12. The method of claim 9, wherein the defining of a things specification comprises describing the things description with a language supporting a Web interface.

13. The method of claim 9, wherein the specializing of an association procedure with respect to the things mediation server comprises configuring a function and a procedure of the things mediation server based on the things description and a subscribe, publish, and notify operation with respect to the things description.

14. The method of claim 9, further comprising publishing the things description to the things mediation server according to a standard of the things mediation server.
